(19) United States
(12) Patent Application Publication
(10) Pub. No.: US 2004/0151656 A1
(43) Pub. Date: Aug. 5, 2004

(54) Modular molecular halogen gas generation system

(76) Inventors: Stephen H. Siegele, Austin, TX (US); Frederick J. Siegele, Austin, TX (US); Daniel B. Hage, Burnet, TX (US); Robert M. Jackson, Burnet, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/716,195

(22) Filed: Nov. 18, 2003

Related U.S. Application Data
(63) Continuation-in-part of application No. 10/038,745, filed on Jan. 2, 2002.
(63) Continuation-in-part of application No. 10/193,864, filed on Jul. 12, 2002.
(63) Continuation-in-part of application No. 10/283,433, filed on Oct. 30, 2002.
(60) Provisional application No. 60/333,405, filed on Nov. 26, 2001.
(60) Provisional application No. 60/333,405, filed on Nov. 26, 2001.
(60) Provisional application No. 60/333,405, filed on Nov. 26, 2001.

(51) Int. Cl. C01B 7/00; B01D 53/34

(52) U.S. Cl. 423/500; 422/168; 422/170; 422/171

(57) ABSTRACT

A system for generating a molecular halogen gas using gas generation modules can provide a flexible platform for scaling to meet increasing demands within a facility. During normal operation, the system may be designed to have one gas generation module in standby mode while the others are in active mode. Adding or removing gas generation cells is relatively straightforward and does not require redesigning the system. The system can be designed with a level of redundancy that best fits the user's needs to allow for continuous uninterruptible operations. The system can be safer to use compared to other systems due to any one or more of electrolytic cell-rectifier pairs, individually exhausted cabinets, organization fluid flow paths and pressures, and the like.

### RELATED APPLICATIONS

This application is a continuation-in-part of and claims priority under 35 U.S.C. § 120 to U.S. patent application Ser. No. 10/038,745 entitled “Method And System For On-Site Generation And Distribution Of A Process Gas” by Jackson filed of Jan. 2, 2002; Ser. No. 10/193,864 entitled “System and Method for On-Site Generation and Distribution of Fluorine for Fabrication Processes” by Siegele et al. filed on Jul. 12, 2002; and Ser. No. 10/283,433 entitled “Generation and Distribution Of Molecular Fluorine Within a Fabrication Facility” by Siegele et al. filed on Oct. 30, 2002, all of which claim priority under 35 U.S.C. § 119 to U.S. Patent Application No. 60/333,405 entitled “System and Method For a Non-Ozone Depleting Material” by Jackson et al. filed of Nov. 26, 2001. All applications referenced within this paragraph are assigned to the current assignee hereof and are incorporated herein by reference.

### TECHNICAL FIELD

The present invention generally relates to systems for generating gases, and more particularly, to systems for generating molecular halogen gases.

### DESCRIPTION OF THE RELATED ART

Consumers are demanding larger and larger displays, such as thin-film transistor liquid crystal displays (“TFT LCD”). For instance, over the next two years, manufacturers of TFT LCD process tools, are expected introduce process tools that can produce 1900×2200 mm screen displays, up from the present 1200 by 1300 mm sizes achievable today. To fabricate these larger screens, process tools require larger chambers. More chamber cleaning gas is needed to clean the larger chambers.

Many industrial facilities, such as electronic device fabrication areas (“fabs”) including TFT LCD fabs, typically run 24 hours per day. Therefore, a continuous, uninterruptible, supply of chamber cleaning gas is paramount.

Historically, chamber cleaning gases, such as NF₃, are produced off-site and then transporting to the fab in vessels. This method has become difficult with the volumes of chamber cleaning gases required by fabrication tools, and particularly for those process tools in TFT LCD fabs. NF₃ suppliers will need to resort to delivering their gasses in tanker-sized vessels. Tanker-sized vessels of NF₃ require special permitting for fabs to store such amounts of gas on-site. Further, tanker-sized vessels of NF₃ also raise difficult safety issues, such as how to handle a leaking the vessel and abate the leaking gas.

### SUMMARY

A system for generating a molecular halogen gas, such as F₂, using gas generation modules can provide a flexible platform for scaling to meet increasing demands within a facility. During normal operation, the system may be designed to have one gas generation module in standby mode while the others are in active mode. The modular design can allow a user to size capacity closer to his or her actual demand and add more modules if the demand is underestimated or increased, rather than intentionally overestimating for speculative fab expansion or additional uses in the future. With the ever-increasing demand for cleaning or feed gases, and particularly non-ozone depleting gases, the ability to produce large amounts on site becomes feasible.

The system can include units, such as a base unit and feed unit, that are common to all gas generation modules.

When a gas generation module is added or removed, equipment within such units do not need to be added or removed. Modifications within such units may include modifying headers and plumbing new lines between the headers and the gas generation modules. The modular design also makes shipping a system easier.

The system can be designed with a level of redundancy that best fits the user's needs. Units common to the system may have at least two pieces for each type of equipment within such units (e.g., two compressors, two traps, two storage containers, two feed containers, etc.). The flow through those units may be designed for an either-or (exclusive-or) arrangement for use of equipment in such units.

The system can be safer to use compared to other systems. Electrolytic cell-rectifier pairs may be implemented to reduce the likelihood of an explosion. Each gas generation cabinet may have only a single electrolytic cell within an individually exhausted cabinet to help confine and contain leaks associated with that particular electrolytic cell. The organization of lines (i.e., tubing), pressure within the lines, and headers are designed to reduce safety issues should a line have a leak or otherwise fail.

In one set of embodiments, a system for generating a molecular halogen gas can comprise gas generation modules. During normal operation, the system can be designed to have at least one of the gas generation modules in standby mode. In another set of embodiments, each of the gas generation modules can comprise a gas generation cabinet and an electrolytic cell within the cabinet. In still another set of embodiments, each gas generation module can comprise an electrolytic cell and a rectifier coupled to the electrolytic cell.

In another aspect, a method for using the system can comprise adding another gas generation module to the system, wherein other additional equipment is not added to another unit (e.g., base or feed unit) within the system.

The foregoing general description and the following detailed description are exemplary and explanatory only and are not restrictive of the invention, as defined in the appended claims.

### BRIEF DESCRIPTION OF THE DRAWINGS

The present invention is illustrated by way of example and not limitation in the accompanying figures.

FIG. 1 includes an illustration of molecular halogen gas generation systems comprising gas generation modules in accordance with an embodiment of the present invention.

FIG. 2 includes an illustration of a molecular halogen gas generation system and at least some equipment within different units of one generation system.

FIG. 3 includes a simplified process flow diagram illustrating the production of a molecular halogen gas in accordance with an embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

A system for generating a molecular halogen gas, such as F₂, using gas generation modules can provide a flexible platform for scaling to meet increasing demands within a facility. During normal operation, the system can be designed to have one gas generation module in standby mode while the others are in active mode. Adding or removing gas generation cells is relatively straightforward and does not require redesigning the system. The system can be designed with a level of redundancy that best fits the user's needs to allow for continuous uninterruptible operations. The system can be safer to use compared to other systems due to any one or more of electrolytic cell-rectifier pairs, individually exhausted cabinets, organization fluid flow paths and pressures, and potentially other features.

A few terms are defined or clarified to aid in understanding the descriptions that follow. The term “active mode” is intended to mean that the corresponding module or other equipment is on and producing or processing a molecular halogen gas.

The term “cabinet” is intended to mean a confinement area and is not limited only to a cabinet-looking structure.

The term “equipment” is intended to mean any apparatus intended to react, filter, pump, or store a material, or any electronic apparatus used to aid in or monitor such reaction, filtering, pumping, or storing. Equipment includes electrolytic cells, compressors, filters, storage containers, rectifiers, and controllers. For the purposes of this specification, equipment does not include tubing or valves.

The term “fluidly coupled” is intended to mean the ability to transfer a principal material or other compound from one point to another without the principal material or other compound undergoing a significant reaction. Non-limiting examples of “fluidly coupled” can fluid flow through tubes, valves (isolation or check), filters, traps, compressors, or the like. While an HF trap can remove residual HF from F2, the F2, which would be the principal material, does not undergo a reaction within the HF trap.

The term “diatomic halogen gas” is intended to mean a gas that only contains two halogen atoms, which may be the same or different atoms. F₂, Cl₂, are Br₂ are examples of diatomic halogen gases. Note that the diatomic halogen gas does not have to be in a gaseous phase and may be in a liquid phase or other fluid state.

The term “hydrogen halide” is intended to mean a molecule that contains a hydrogen atom and a halogen atom. HF, HCl, and HBr are examples of hydrogen halides.

The term “molecular halogen gas” is intended to mean a molecule that contains at least one halogen atom. F₂, Br₂, Cl₂, and NF₃ are examples of molecular fluorine gases. Note that the molecular halogen gas does not have to be in a gaseous phase and may be in a liquid phase or other fluid state.

The term “standby mode” is intended to mean that the corresponding module or other equipment is not producing or processing a molecular halogen gas. Note that standby mode includes other non-production states, such as routine maintenance and is not limited only to a state where the module or other equipment can immediately be switched to active mode.

As used herein, the terms “comprises,” “comprising,” “includes,” “including,” “has,” “having” or any other variation thereof, are intended to cover a non-exclusive inclusion. For example, a process, process, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

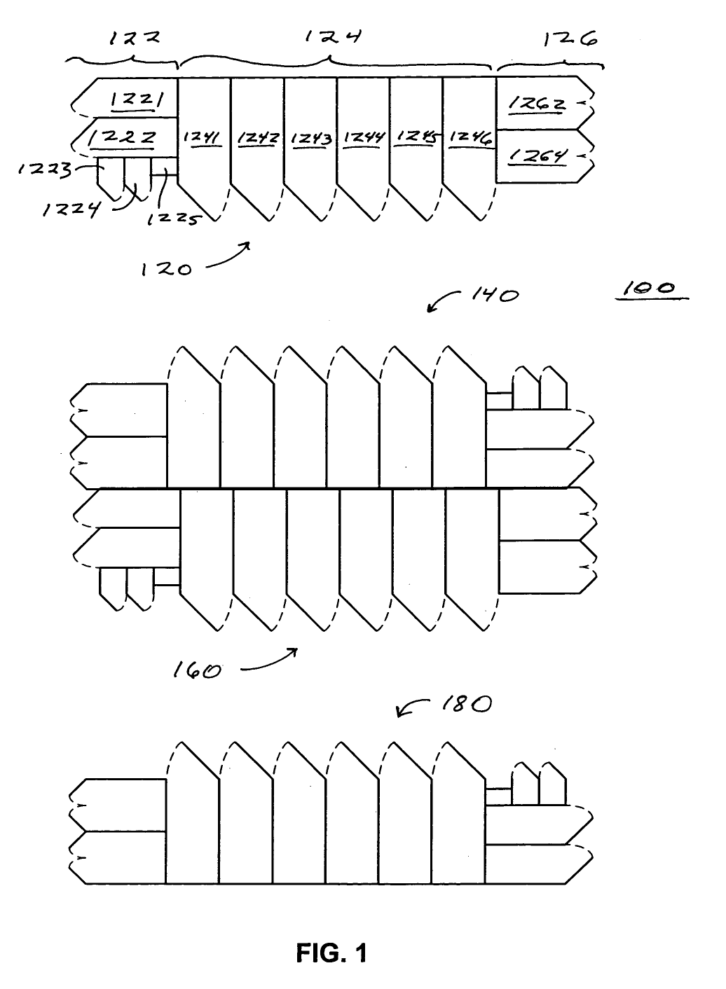

Attention is now directed to details of non-limiting embodiments. FIG. 1 includes an illustration of molecular halogen gas generation area 100 (“area 100”) comprising molecular halogen gas generating systems 120, 140, 160, and 180. Each of molecular halogen gas generating systems 120, 140, 160, and 180 may generate F₂ from HF, Cl₂ from HCl, Br₂ from HBr, NF₃ from NH₄F.HF, or the like. After reading the specification, skilled artisans will appreciate that some differences for the different gasses may exist. For example, while Br₂ is typically a liquid when at substantially atmospheric pressure and room temperature (approximately 20° C.), the system may be operated under vacuum, at a temperature higher than room temperature, or a combination thereof if Br₂ is to be in a gaseous state. To simplify the description below, the generation of F₂ from anhydrous HF (AHF) is addressed.

More or fewer gas generating systems may be present in area 100. Area 100 may be located within or near a site that should have a continuous, uninterruptible supply of a molecular halogen gas, which in this embodiment is F₂. As the systems are placed closer to where the F₂ is used, potential safety issues may be reduced because transportation of the F₂ in tanks and long tubing runs (e.g., more than 500 meters long) between a storage container and any of the process tools may be obviated.

Each pair of systems (e.g., a combination of systems 120 and 140) in area 100 may occupy approximately 12×13 meters (approximately 40×42 feet) to allow for appropriate access to cabinets with the systems. Each of the cabinets is illustrated as having one or more doors that allow for easy access to different parts of the system. The design is flexible in that it may be scaled to many different sizes depending on the specified usage rate within the fab. The design flexibility is described in more detail below.

System 120 comprises base unit 122, gas generation unit 124, and feed unit 126. Each unit is described in more detail below.

Base unit 122 comprises the common equipment for processing the F₂ after it has been produced. Base unit 122 comprises storage cabinets 1221 and 1222 and trap cabinets 1223 and 1224. Each of the storage cabinets 1221 and 1222 may have substantially the same equipment, and each of the trap cabinets 1223 and 1224 may also have substantially the same equipment. By having two sets of equipment, sufficient redundancy exists while keeping capital expenditures and area occupied by the equipment relatively low. For example, one HF trap may be used to remove residual HF from an F₂ gas stream while the other HF trap is being regenerated. Specific equipment within the cabinets is described later in this specification.

In alternative embodiments, more or fewer of cabinets 1221, 1222, 1223, and 1224 may be used. If only one storage cabinet and one trap cabinet is used, no redundancy may exist, and therefore, the user runs the risk of having to take the entire system down if one component (e.g., a compressor, a storage container, or an HF trap) fails or needs routine maintenance. More cabinets (three or more of each type) may be used to improve redundancy, but the capital expenditures and the area occupied by a system increases. While any number of storage and trap cabinets may be used, two of each provides a good balance between redundancy versus capital expenditures for additional equipment and the area it occupies.

Base unit 122 also comprises main control station 1225. As will be described later, each of gas generation modules 1241-1246 has a local controller electrically coupled to main control station 1225. Each of the local controllers may be monitored and operated from main control station 1225.

System 120 also comprises gas generation unit 124, which includes gas generation modules 1241-1246. Each of the gas generation modules 1241-1246 can operate independently of the other gas generation modules. Under normal operating conditions, one gas generation module is in standby mode, while the other gas generation modules are actively producing F₂ gas in active mode. While in standby mode, the gas generation module may receive maintenance or be ready and waiting to be switched to active mode. When the switch occurs, a different one of the gas generating modules may be switched from active mode to standby mode. In other words, module 1241 may be in standby mode while modules 1242-1246 are in active mode. Module 1241 may be switched to active mode, and modules 1242 may be switched to standby mode, while the rest of modules 1243-1246 remain active. Note that during the switch, both gas generation modules may be in active mode or standby mode simultaneously for a relative short period of time.

In an alternative embodiment, all modules 1241-1246 may be in active mode to produce the greatest amount of F₂ gas from system 120. However, if any one or more of the modules 1241-1246 are placed in standby mode, the production rate from system 120 will be reduced.

In the configuration shown in FIG. 1, system 120 can produce approximately 7 Kg/hour of F₂. Theoretically, the modular design allows any number of gas generation modules to be used in a system. The actual number may be limited by other considerations, such as the size of area 100 or other constraints. More or fewer gas generation modules, systems, or both may be used. Area 100 is designed produce up to approximately 28 Kg/hour of F₂, although higher or lower rates are possible depending on the size of the electrolytic cells and the number of the gas generation modules that are in active mode. The flexibility of design allows many different configurations to be possible.

System 120 also comprises feed unit 126. Feed unit 126 comprises two cabinets 1262 and 1264 that provide AHF for gas generation modules 1241-1246.

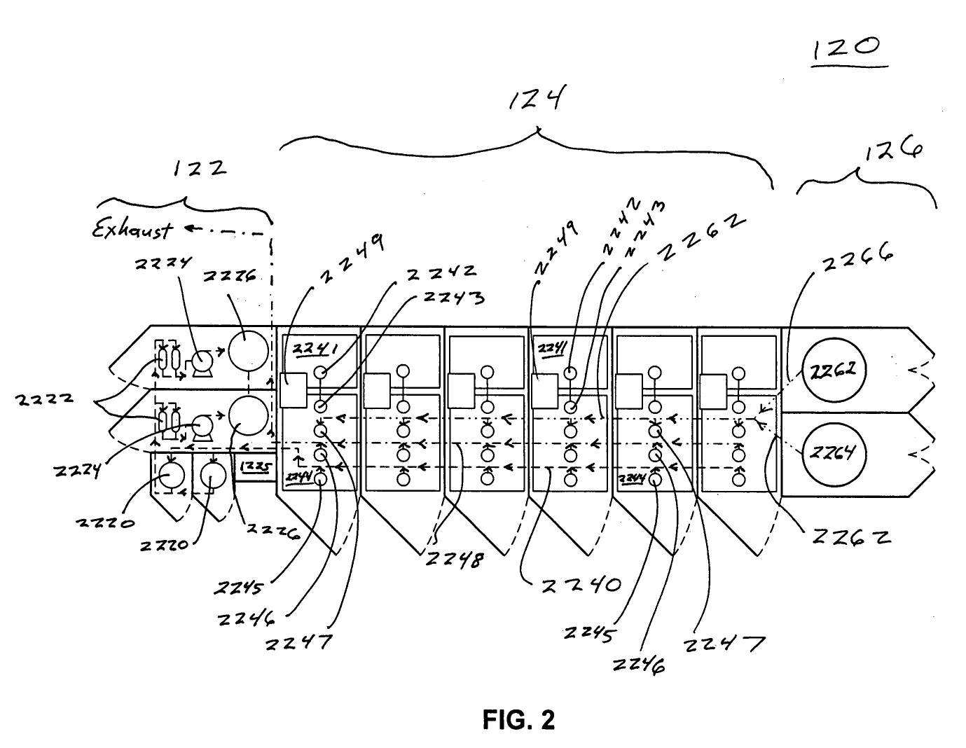

FIG. 2 includes an illustration of a more detailed view of system 120 including base unit 122, gas generation unit 124, and feed unit 126.

Within base unit 122, each of storage cabinets 1221 and 1222 may comprise a set of filters 2222, compressor 2224, and storage container 2226. In an alternative embodiment, either or both of cabinets may have one or more additional sets of filters, compressors, and storage containers. Each of trap cabinets 1223 and 1224 may comprise HF trap 2220, which is to remove residual HF from the F₂ product effluent. HF trap 2220 may comprise NaF. In an alternative embodiment, either or both of trap cabinets 1223 and 1224 may have one or more additional HF traps.

Each of gas generation modules 1241-1246 can comprise one electrolytic cell 2244 and one rectifier 2241. Electrolytic cell 2244 and rectifier 2241 are electrically coupled to each other at electrical terminals 2242 and 2243 within a circuit to power electrolytic cell 2244 and produce molecular halogen gas. Electrical terminal 2243 may be electrically connected to the anode of electrolytic cell 2244. Alternatively, the electrical terminal 2243 may be electrically connected to the cathode of electrolytic cell 2244.

Rectifier 2241 may be sized such that, even if there is an electrical failure in the circuit, explosion of electrolytic cell 2244 is substantially prevented. The design using individual pairs of rectifiers 2241 and electrolytic cells 2244 improves safety and reliability of the system. In one embodiment, the electrical failure may be an anode failure within electrolytic cell 2244. The maximum current from the rectifier 2241 may flow through electrolytic cell 2244. Because rectifier 2241 has been appropriately sized, the likelihood of explosion is substantially eliminated.

Compare the rectifier-electrolytic cell pair design to a different system where a common rectifier is shared between all electrolytic cells 2244 in FIG. 2. Electrical current will flow easier in the path of least resistance. If an anode failure in one electrolytic cell effectively causes an electrical short, most, if not substantially all, of the electrical current, which may be several thousands of amps, from the common rectifier may flow through the electrically shorted electrolytic cell causing the gas generation rate to be too high and potentially result in an explosion.

In alterative embodiment, rectifier 2241 may not need to be hard wired to only one electrolytic cell 2244. For example, a rectifier may be coupled to all of electrolytic cells 2244 in FIG. 2. However, through the use of appropriate switches, logic (hard coding, software, firmware, etc.) or any combination thereof, a single rectifier may operate with only one electrolytic cell at a time. For example, if rectifier 2241 in module 1241 is defective and electrolytic cell 2244 in module 1242 is off for routine maintenance, appropriate switches may be used so that rectifier 2241 from module 1242 and electrolytic cell 2244 from module 1241 form a single rectifier-electrolytic cell pair within a circuit.

In another alternative embodiment, a single rectifier may be used with more than one electrolytic cell at a time. However, this configuration may be done if the rectifier can be sized so that it (1) can support more than one electrolytic cell and (2) not cause an explosion should an electrical failure occur. This embodiment should not be used if both conditions cannot be met simultaneously.

Each of modules 1241-1246 includes HF port 2247, H₂ port 2246, and F₂ port 2245. Each of HF ports 2247 may be connected to HF feed line 2262 (represented by a dash-dot-dot-dash line convention). Each of H₂ ports 2246 may be connected to H₂ exhaust line 2248 (represented by a dash-dot-dash line convention), and each of F₂ ports 2245 may be connected to F₂ product line 2240 (represented by a dashed line convention). Arrows for lines 2240, 2248, and 2262 illustrate the designed direction of flow within the lines. Headers (not shown) for lines 2240, 2248, and 2262 may or may not lie within the gas generation unit 124. For example, an F₂ header may lie within base unit 122 with individual lines between F₂ ports 2245 and the F₂ header, an H₂ header may lie within base unit 122 with individual lines between H₂ ports 2246 and the H₂ header, or both. Similarly, an HF header may lie within feed unit 126 with individual lines between HF ports 2247 and HF header. In an alternative embodiment, any one or more of the headers may lie within unit 124 and have taps for the individual ports for each gas generation module.

Feed unit 126 may comprise feed containers 2262 and 2264 that are connected to HF feed line 2262. Each of feed containers 2262 and 2264 may comprise an intermediate bulk container (“IBC”). With the configuration shown in FIG. 1, each feed container 2262 and 2264 can supply HF to system 120 for a week. The level of redundancy for the feed unit 126 can be similar to that used for the base unit 122.

Note that many items within FIG. 2 are fluidly coupled to one another and may or may not be connected to each other. For example, each of electrolytic cells 2244 are fluidly coupled to storage tanks 2226, although none of electrolytic cells 2244 are directly connected to either of storage tanks 2226.

The other systems 140, 160, and 180 are configured to be nearly identical to system 120. In other embodiments, systems 120, 140, 160, and 180 may differ. For example, system 140 may have only three gas generation modules, and system 160 may have six gas generation modules. Again, flexibility of configuration is an advantage of the design.

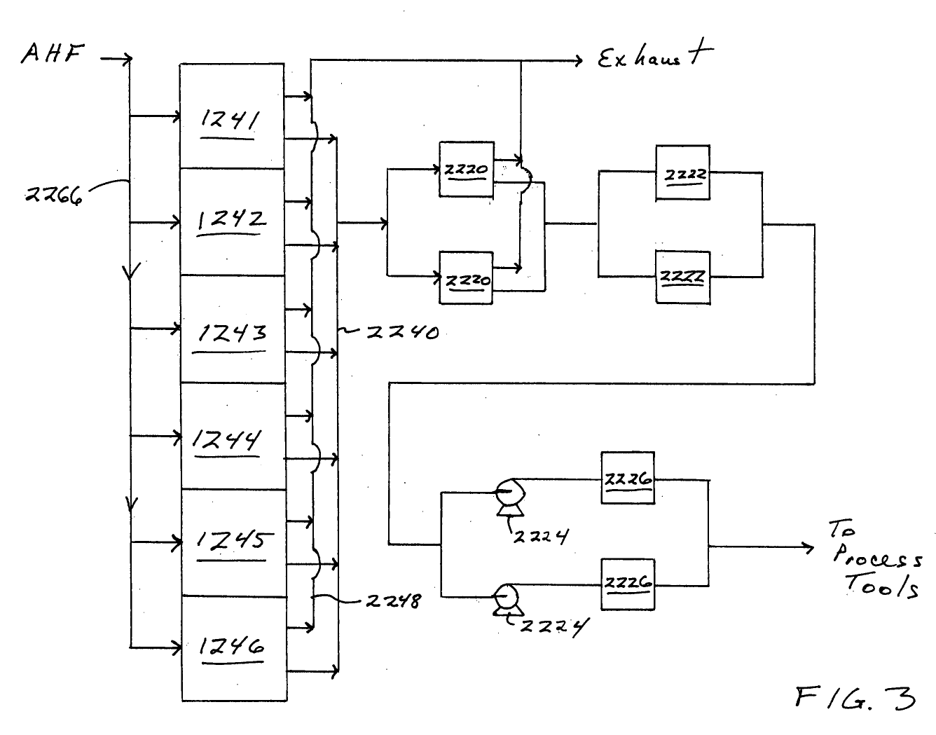

Attention is now directed to a simplified process flow for using system 120 as illustrated in FIG. 3. A notable aspect of system 120 is the redundancy of equipment to reduce the likelihood of having to shut down all of system 120. Operation of the other systems 140, 160, and 180 will be substantially identical to that described for system 120. For simplicity, check valves, isolation valves, temperature and pressure sensors, heating and cooling units, and the like are not illustrated although skilled artisans will appreciate where and how to implement each within system 120.

Each of the gas generation modules 1241-1246 has local controller 2249, such as a programmable logic controller, to monitor and operate equipment (e.g., electrolytic cell 2244, rectifier 2241, and valves (not shown) within its corresponding module. Base unit 122 and feed unit 126 may include one or more local controllers (not shown), too. Any or all of the local controllers can be electrically coupled to main control station 1225 within base unit 122. In this manner, a global view of system 120 is possible.

AHF can be fed through HF feed line 2266 to each of gas generation modules 1241-1246. In one embodiment, one of gas generation modules 1241-1246 is in standby mode. Because one of gas generation modules 1241-1246 is in standby mode, an isolation valve (not shown) for such module may be closed while all other isolation valves (not shown) for all other modules between HF feed line 2247 and the other gas generation modules may be opened. All gas generation modules 1241-1246 except the one in standby mode can produce H₂ at a cathode of electrolytic cell 2244 and F₂ at an anode of electrolytic cell 2244. H₂ is removed by H₂ exhaust line 2248 and is routed to an exhaust. The exhaust line may include an H₂ burn box and any one or more scrubbers (wet (acidic, basic, or neutral) or dry). The exhaust and subsequent processing of the exhaust gasses is conventional.

F₂ may flow through the F₂ product line 2240 to one of HF traps 2220. HF trap 2220 may include NaF to remove residual HF from the F₂. While one HF trap 2220 is active, the other HF trap 2220 may be regenerated. An inert gas, such as N₂, He, Ar, or the like, may be used to remove the HF from HF trap 2220 during regeneration. The regenerating HF trap may be heated during regeneration to keep regeneration times acceptably low. The exhaust from the regeneration, which includes HF and the inert gas, flows to the exhaust. The other HF trap, which is in active mode, is used to remove residual HF from F₂ before the F₂ flows to one of a set of filters 2222 to remove solids.

Each set of filters (illustrated by box 2222 in FIG. 3) includes two or more filters connected in parallel. When the pressure differential across a filter becomes too high or the outlet pressure from a filter becomes too low, system 120 via local controller 2249 or main control station 1225 can switch from one filter to another within a set or between sets of filters. The filter with the high differential pressure or low outlet pressure may be cleaned.

After the sets of filters 2240, F₂ may flow to either of a pair of compressor 2244 and F₂ storage tank 2226. The F₂ may be sent from F₂ storage tanks 2226 to the locations where F₂ is needed, such as process tools. Alternatively, the F₂ may be further filtered, purified, or sent to other storage location(s) (e.g., closer to each process tool).

The operation of other systems 140, 160, and 180 are substantially identical to the operation of system 120.

In alternate embodiments, different feed materials may be used and different molecular halogen gases may be generated. For example, HCl can be used to generate Cl₂, and HBr can be used to generate Br₂. HF traps 2220 may be replaced by HCl or HBr traps.

In another embodiment, all gas generation modules 1241-1246 may be in active mode. This configuration can allow for the highest production rate from system 120, but does not allow for any redundancy for the gas generation modules. If any one or more of the gas generation modules 1241-1246 shut down or need maintenance, the production rate will decrease.

In still another alternative embodiment, NH₄F.HF can be used to generate NF₃ using electrolytic cells 2244. The electrolytic cells may operate at a temperature of at least 126° C. so that NH₄F.HF remains in a molten (liquid) state. Alternatively, KF.NH₄F.HF may be used. Feed and gas outlet ports and adjacent portions of lines for the electrolytic cell may also be heated to reduce the likelihood of NH₄F.HF vapor solidifying on or near the ports. Additionally, a cold trap (not shown) may be used to remove NH₄F.HF before it reaches HF traps 2220 or the exhaust (for the cathode gas line).

Embodiments described herein are particularly well suited for operations needing substantial amounts of molecular halogen gas for nearly any purpose, particularly those operations needing a continuous, uninterruptible source of a molecular halogen gas. One application may include cleaning deposition chambers, such as deposition chambers that process very large substrates. Therefore, the systems can be designed to provide sufficient F₂ or other molecular halogen gas to clean deposition chambers designed to process substrates of 1900×2200 mm and even larger. By correctly sizing the generator system to demand, minimal inventories of F₂ or other molecular halogen gas may be on-site at any given time. In other applications, system 120 can be used to produce a molecular halogen gas used to etch such substrates or to produce molecular halogen gas for other uses. For example, system 100 may produce NF₃ that may be used to form N₂F₄, perfluoroamine salts, or other halogen-containing chemicals.

Each of system 120, 140, 160, and 180 is modular in design and utilizes a single standardized platform. The single standardized platform may contain items such as main controller station 1225, compressors 2224, storage containers 2226, and manifolds. The platform is engineered to accommodate any number of gas generation modules, so that nearly any demand requirement can be accommodated.

Up front capital expenses are only as high as they need to be to supply the current demand of molecular halogen gas. Then if demand later increases, more gas generation modules may be added to the platform without having to purchase another system and without experiencing the significant downtime required to swap out a smaller fluorine generator for a larger generator. As an example, a user may have two active and one standby gas generation modules. Later, if his or her demand increases, more gas generation modules can be added to a pre-existing system without significant modification to the system platform, and specifically base unit 122 and feed unit 126.

Additionally, the modular design is easier to ship. Modular components can be broken down easily for shipment. Each unit or modules has a lower shipping weight and smaller individual size compared to a fully unitized system (one big electrolytic cell).

The design allows for sufficient redundancy to achieve molecular halogen gas production that can be continuous and uninterruptible. By centralizing several highly reliable functions, like the compressors, storage containers, traps, manifolds, and filtration, cost and complexity can be reduced without affecting system uptime. If a compressor fails, another compressor is in standby mode ready to come on-line. Similarly, duplicate traps, duplicate sets of filters, and the like can be used.

Electrolytic cells 2244 can be housed in their own individual cabinet to provide a number of benefits. By using several cells, continued operation can occur without losing significant molecular halogen gas generation capacity should one or more of the cells fail. Cell size can be designed such that it is not so large as to require internal cooling, thereby eliminating the possibility of water leaking into the cell through the interior cooling units (typically weld failure), which historically has been problematic with cells that use internal cooling. Water can cause irreparable damage to electrolytic cells 2244 and may cause uncontrolled reactions, explosions, or both due to the water and fluorine mixture.

Another benefit for embodiments described herein is that the product gas as output from any one or more of the system 120, 140, 160, and 180 is more consistent. Such consistency can be achieved because the molecular halogen gas produced is a homogeneous mixture generated from different electrolytic cells and is not reliant on one particular electrolytic cell.

The pressure differential between electrolytic cells 2244 and an active compressor 2224 can be zero to a negative pressure (compressor 2224 would be at the lower pressure). Such a configuration is safer than positive pressure in case of line break in product line(s). Similarly, in one embodiment, the use of multiple feed lines can help to minimize the pressure in the feed lines and the amount of feed (e.g., HF) in any single line. Again, this configuration is safer than using one large feed line.

Each cell can be individually shut down and accessed for service without shutting down the remainder of the system or the other electrolytic cells 2244, thereby approaching a continuously operating system and minimizing any complete shut down of any one or more systems 120, 140, 160, or 180 for maintenance. For example, in event of electrolytic cell 2244 failure (e.g., anode failure), that cell 2244 can be isolated and the remainder of system may remain in operation. More than one of electrolytic cells 2244 may be in standby mode at any point in time. As long as at least one electrolytic cell 2244 is active, molecular halogen gas may be produced.

As shown and described in FIG. 1, many different cabinets are used in system 120, 140, 160, and 180 and are individually exhausted. Individually exhausted cabinets minimize the amount of any accidental release of F₂, HF or other dangerous fluids.

Explosions due to electrical failure are substantially reduced. Each rectifier may be dedicated to an electrolytic cell to substantially eliminate the possibility of exceeding the allowable electricity to any given cell, which can be catastrophic and cause cell explosion. Historically, in multi-cell F₂ generating systems, one large rectifier supplies power to several electrolytic cells. This historic design allows for certain failures to overload an electrolytic cell with electricity, potentially causing an explosion as previously described.

The systems are designed to improve safety. Each system does not rely on only one set of critical monitoring systems. Redundancy of the electrolytic cells, their life safety systems (e.g., individually exhausted cabinets), and critical monitoring equipment substantially eliminates the possibility of catastrophic single point failures. Therefore, under this system, a user may have a small problem but will unlikely have a single big problem that could shut down an entire system. By segmenting the potentially dangerous processes, the possibility of large catastrophes is virtually eliminated.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. A system for generating a molecular halogen gas, wherein the system comprises gas generation modules, wherein during normal operation, the system is designed to have at least one of the gas generation modules in standby mode.

2. The system of claim 1, further comprising a first molecular halogen storage container coupled to each of the gas generation modules.

3. The system of claim 2, further comprising a first hydrogen halide trap coupled to the first molecular halogen storage container.

4. The system of claim 3, further comprising a first filter coupled to the first molecular halogen storage container.

5. The system of claim 4, further comprising a second molecular halogen storage container, a second hydrogen halide trap, and a second filter, wherein:
the first and second molecular halogen storage containers are connected in parallel and coupled to each of the gas generation modules;
the first and second hydrogen halide traps are connected in parallel and coupled to each of the gas generation modules; and
the first and second filters are connected in parallel and coupled to each of the gas generation modules.

6. The system of claim 5, wherein:
the first molecular halogen storage container, the first hydrogen halide trap, and the first filters are located within a first cabinet separate from the gas generation modules;
the second molecular halogen storage container, the second hydrogen halide trap, and the second filter are located within a second cabinet separate from the first cabinet and the gas generation modules;
the first hydrogen halide trap is located within a third cabinet; and
the second hydrogen halide trap is located within a fourth cabinet.

7. The system of claim 1, wherein each gas generation module comprises an electrolytic cell and a rectifier.

8. The system of claim 1, wherein each gas generation module has its own cabinet.

9. The system of claim 1, wherein the molecular halogen gas is F2, and a feed material for the gas generation module comprises HF.

10. A system for generating a molecular halogen gas comprising gas generation modules, wherein each of the gas generation modules comprises a gas generation cabinet and an electrolytic cell within the cabinet.

11. The system of claim 10, wherein each gas generation cabinet comprises a single electrolytic cell.

12. The system of claim 11, wherein each gas generation cabinet further comprises a rectifier and a controller.

13. The system of claim 10, wherein the molecular halogen gas is F₂, and a feed material for the gas generation module comprises HF.

14. A system for generating a molecular halogen gas, wherein the system comprises gas generation modules, wherein each gas generation modules comprises:
an electrolytic cell; and
a rectifier coupled to the electrolytic cell.

15. The system of claim 14, wherein for at least one of the gas generation modules:
the electrolytic cell and rectifier are part of a circuit; and
each rectifier is sized to substantially prevent an explosion of the electrolytic cell in the event of an electrical failure within the circuit.

16. The system of claim 15, wherein the electrical failure includes an anode failure within the electrolytic cell.

17. The system of claim 14, wherein the rectifier is configured to be operated with only a single electrolytic cell at a time.

18. The system of claim 14, wherein the molecular halogen gas is F₂, and a feed material for the gas generation module comprises HF.

19. A method for using a system to generate a molecular halogen gas, wherein the system comprises gas generation modules and another unit, wherein the method comprises adding another gas generation module to the system, wherein additional equipment is not added to the other unit.

20. The method of claim 19, wherein the other unit includes a base unit or a feed unit.

21. The method of claim 20, further comprising modifying a header with the other unit.
